(19) United States
(12) Patent Application Publication
(10) Pub. No.: US 2004/0096802 A1
(43) Pub. Date: May 20, 2004

(54) Apparatus for precise registration and articulation of dental stone replicas

(76) Inventor: Neal B. Gittleman, Houston, TX (US)

Correspondence Address: Ezra L. Schacht, 1620 West Main Street, Houston, TX, 77006, US

(21) Appl. No.: 10/298,026

(22) Filed: Nov. 16, 2002

(51) Int. Cl. A61C 9/00; A61C 11/00

(52) U.S. Cl. 433/71; 433/60

(57) ABSTRACT

An aligning dental impression transfer method and apparatus is described in which the transfer of the bite registration in centric occlusion is accurately preserved from a triple tray impression to the positioning upon an articulator. At each stage of the casting of a working model the spatial relationship of existing dental structures are preserved. The cast model of the upper and lower dentition a in perfect registration on the articulator. In the process of manufacturing molded and machined parts, the limitations in dimensional accuracy exceed those desired by the dental patient. The patient is aware of binding or interfering “high spots” greater than 5 microns. The modern cavity mold and resulting thermoplastic parts cannot be expected to hold these dimensions. These variations in dimensional tolerance are eliminated in this invention. The articulator is equipped with an upper and lower frame with magnetic or other clamping means to hold the pin blocks in preliminary alignment. During the casting procedure, accurate alignment projections are cast using the same stone slurry compound used to make the dental stone casts. Mounting holes in the pin block are positioned over conical recesses in the mating articulator plate and held in place by the magnetic clamps. The slurry is poured and hardens to form conical projections fixed to pin block but removable from the mating conical recesses. Now the pin blocks can be removed and accurately repositioned in the articulator frame. Each conical projection is cast-in-place in each conical recess guaranteeing accurate alignment.

### BACKGROUND OF THE INVENTION

An innovative technique for producing a registered bite image of the teeth in centric occlusion begins with the molding of both the upper and lower teeth using a triple tray. The triple tray is formed from a rigid plastic or metal frame having a lingual and buccal sidewall dam and a thin, porous mesh in the occlusal plane. This mesh is fine enough to allow good occlusion and still act as a support for a quick setting elastomeric compound of polysiloxane or other polymer that solidify to form a resilient rubber mold of the teeth in detail. Triple trays are available for the left or right dental arch and the anterior arch. The triple tray takes three simultaneous impressions of the upper and lower teeth, as well as the bite registration, thus earning its name. As an example, in the right arch, the “U” shaped frame is rigid enough to prevent the rubbery impression compound from expanding outward is subsequent casting procedures. This will prevent dimensional inaccuracies in the final restoration An aluminum or steel frame has the necessary rigidity while occupying little space within the mouth. A convenient handle aids in the proper placement of the triple tray.

The triple tray with its embedded and solidified impressions is sent to the dental laboratory for further processing. A set of positive stone casts made from a quick setting plaster are formed within both the upper and lower negative impressions. Registering and attaching these positive stone casts is the subject of this invention. It is desirable that these stone casts are manipulated to mimic the variety of motions of the jaw to provide efficient and comfortable chewing. This is especially necessary when several missing teeth are being restored The dental practitioner must craft the opposing surfaces while moving the stone casts from side to side and forward and backward matching the dynamic occlusal activity of the jaw. Prosthetic cusps and fossae are sculpted where necessary to provide the crushing, grinding and cutting action of the natural teeth. Often, the dental practitioner or laboratory artisan can improve upon the less than optimal dentition provided by inheritance. The upper and lower casts are held in an articulator in such a manner as to mimic the complex motion of the human jaw The articulator of choice in this invention consists of a somewhat flexible hinged assembly having a radial opening and closing motion like that of the jaw. In addition the flexing motion of the side members allow the dental practitioner or artisan to manipulate the stone casts by hand. The articulator is provided with frontal stops.

The current techniques in sophisticated dental laboratories are reliant upon the knowledge and skill of the well-trained dental technician to produce prosthetic crowns and bridges that match the opposing dentition. When working with separate casts of the upper and lower arch of the jaw, the technician can often attach the casts to an articulator to simulate the complex motion of the jaw by visual inspection with good accuracy. In some cases however, the technician must interpolate the desired occlusion. This may be the result of missing or poorly matching teeth. The use of the triple tray gives the technician a tool to replicate prosthetics that best meet the patient's own sense of the best bite pattern. In this manner the patient is most pleased with the results. However, if the technician should misalign the upper and lower casts by more than a few microns in cementing them to the jaws of the articulator, the patient will notice the misalignment in the resulting prosthesis.

If one or more teeth being restored are sectioned from the stone cast to allow for easier manipulation while building up the prosthesis, they must be accurately replaced among the other replicas of unaltered teeth in the stone cast. This is often done with alignment or registration pins that are easily slid in and out of matching receptacles formed in a stone base.

The current method involves a set pair of opposing blocks with repositionable pins. The technician locates the optimal pin position within a block having an array of closely spaced holes. The pins are equipped with heads or a knurled region to hold firmly within the stone cast. The triple tray is studied to determine the best pin placement and the pin block is marked with waterproof ink on the side. The plaster slurry is fed into one side of the impression. A vibrating table, having a jarring, vertical motion, forces the thixotropic slurry to flow into each detail of the mold, while driving any entrained bubbles to the top. A thixotropic slurry is understood to have the properties of flowing under the stress of a jarring motion and retaining its shape when undisturbed. The first pin block with the pins in place is manually positioned over the triple tray and registered by sight by the dental technician. The opposing positive stone cast is made using the same procedure by inverting the triple tray and filling the lower plaster recess with plaster slurry. After the plaster has set, the positive stone cast is carefully removed from triple tray impression while still attached to the pin block. The stone cast can be sectioned with a thin saw down to the pin block. Each section can be removed and replace by sliding the pins out of and back into the block to facilitate the hand operations needed to properly polish and fit the prosthesis.

Most pin block assemblies in current usage have a molded hinge assembly to form a simple articulator to mimic the action of the jaw. Separately mounting these pin blocks on sophisticated articulators will introduce alignment errors. Overcoming limitations in manually placing and manipulation the stone casts and molded pin blocks on articulators are the subject of this invention.

### IMPROVEMENTS IN THE ART

In the process of manufacturing molded and machined parts, the limitations in dimensional accuracy exceed those desired by the dental patient. The patient is aware of binding or interfering “high spots” greater than 5 microns. The modern cavity mold and resulting thermoplastic parts cannot be expected to hold these dimensions. These variations in dimensional tolerance are eliminated in this invention.

If a molded pin block is equipped with four corner holes to be aligned over four tapered pins or posts on the articulator frame, what can be expected in alignment? The minimum machine tolerance of most modern milling centers is ±0.0002 inches (5 microns) in a single plane. This alignment error will accumulate over the four posts to at least 0.0004 inches (10 microns) and more, given the fact that the holes are cast in a thermoplastic polymer pin block with additional shifts in position as the thermoplastic pin block cools and ages. These dimensions exceed the patient's sense of proper tooth registration in the mouth. Transferring both the bottom and top plastic pin blocks to the articulator jaws will compound the misalignment.

Using the articulator as the casting frame will substantially reduce alignment errors. Casting the alignment registry “in situ” will eliminate misalignment between the articulator frame and the pin blocks. The articulator frame top and bottom will have at least two shallow recesses on each. In the examples shown, there are four shallow recesses or tapered, truncated cones that project inward. The pin block will have four matching through holes that center over the cone-shaped recesses. Together, a through-hole and tapered recess form an alignment post mold. A mechanical or magnetic clamp holds the pin block in “loose” registration with the four alignment cone-shaped recesses while a small amount of stone casting compound slurry is poured in each of these through-hole wells and into the shallow recesses. Upon solidification these positive, tapered alignment posts rigidly attached to the pin blocks provide near perfect registration between the plastic pin block and the articulator frame. A countersink or taper within the pin block through-hole will prevent the stone casting compound from loosening within the pin block. A mold release coating is applied to surface of the articulator frame in and around the cone-shaped recesses to prevent the alignment posts from sticking to the articulator frame. The pin block can be repeatedly removed and replaced on the articulator jaw in the exact same position using the cast alignment posts.

The steps used for an accurate upper and lower model areas follows:

The triple tray impression is taken.

The triple tray is clamped between the upper and lower frames of the articulator in the occlusal plane.

Mold release coating is applied to surfaces of the articulator frames in and around the truncated cone-shaped recesses to prevent the alignment posts from sticking to the articulator frame. Mold release coatings are applied to the pin block where the stone models are formed.

The upper negative mold of the triple tray is filled with stone slurry and vibrated into place. Additional stone slurry is mounded upward to form a base.

The pin block with pins in the desired location is lowered in place on the upper articulator frame and the pins embedded within the wet stone compound in the triple tray. The pin block is held flush against the articulator frame face by magnetic or mechanical clamping means.

Each of the four through-hole wells in the pin block is filled with stone slurry to form the tapered stone registration posts in the pin block that mate with the registration recesses in the articulator top frame.

After the stone has set, every element in the articulator assembly will have near perfect registration.

The articulator is inverted. The same procedure is followed with the lower negative mold of the triple tray.

Since each element is cast in registration with “zero” tolerance, the articulator now has an upper and lower model of the dental arches in near perfect, centric occlusion. Each of the pin blocks can be removed from the articulator frame and then replaced in registration without concern about inaccurately machined tolerances.

The articulator has an upper and lower arm attached to the upper and lower frame respectively. The upper and lower arms meet at a hinge assembly that mimics the overall motion of the jaw. At least one of these arms has an elastically flexible element that will allow the two frames to move in lateral and anterior directions to mimic the complex motions of the jaws. When not being manipulated, the articulator frames return to an aligned resting position.

A means to clamp and hold the triple tray in the occlusal plane of the articulator is provided. A sheet of clear flexible plastic film placed under the triple tray can protect the bottom portion of the articulator from splashes and drops of slurry compound.

The apparatus of this invention consist of the following elements:

A triple tray constructed of a sturdy frame and a thin porous membrane mounted on this frame in the occlusal plane known to the art with recesses molded into the triple tray handle to mate with matching projections on the articulator triple tray holding clamp.

A set of upper and lower pin blocks with a multitude of evenly spaced tapered through-holes, each plugged with a removable rubber plug. The pin blocks are made from a transparent, rigid polymer. The plugs are made of a resilient polymer. The pin blocks have embedded magnetic alloy or soft iron inserts which are magnetically attracted to matching magnets fixed within the top and bottom surfaces of the articulator upper and lower frames. Alternately, a set of mechanical clamps attached to the articulator frames are used to hold the pin blocks in place.

A plurality of tapered pins having a tapered base matching the tapered through-holes in the articulator pin blocks and having a knurled or otherwise machined head to hold the pin within hardened stone.

An articulator designed to removably hold the pin block assemblies.

Outline of the steps.

The dentist takes a triple tray impression of the upper and lower jaw with the teeth held shut in the normal bite position known as centric closure. A single quadrant, left or right or an anterior registration is captured. A full dental arch is also possible. The preferred impression material used is a quick setting polymer paste, which sets to a rubbery solid. Every detail of the dentition and surrounding soft tissue is captured.

The triple tray is removed from the patient's mouth and sent to a lab. If necessary, the excess rubber compound is trimmed from the surrounding areas of the triple tray, taking care not to disturb the areas of interest.

An articulator pin block is prepared with removable tapered pins to match the specific restoration areas One or more replicated portions of the positive stone cast will be removably attached to the articulator pin block by means of these tapered pins. The pin block is equipped with a multitude of equally spaced tapered holes, each sealed with a removable rubber plug. The plugs corresponding to the desired pin positions are punched out leaving an empty tapered hole for each desired pin placement. Alternately, a protective sheet of thin film is applied in the pin block manufacturing procedure to cover each tapered hole. The desired pins are punched through the film at the desired locations. Adhesive backed thin films of stable polymers are currently available.

Portions of the pin block assembly and articulator are thinly coated with a mold release compound to aid in freeing the set stone model from the articulator and pin block.

A slurry of stone compound plaster is mixed and degassed according to the manufacturer's instructions.

The upper negative image recess of the triple tray is filled with slurry and bubbles are forced to the top with a tabletop, impact vibrator. Additional slurry is built up to form a stone base.

The prepared articulator block is inverted in the properly keyed location with the pins in place and embedded in the built up stone base slurry compound.

A set of conical alignment projections are cast into mating recesses in the upper articulator frame using the same stone slurry compound.

The stone is allowed to harden. The positive stone cast is left in place and the whole articulator assemblage is turned upside down.

Now the lower articulator block with tapered pins inserted is prepared in the same manner as the upper block.

Plaster slurry is carefully ladled and vibrated into the triple tray lower impression. The lower articulator block with its alignment pins in place is set and keyed into the plaster slurry.

After hardening, the triple tray is removed from the upper and lower positive cast. The pin blocks with their respective positive stone casts now can be removed and replaced with accuracy.

Centric occlusion is preserved since both the upper and lower stone casts are registered to the upper and lower pin blocks and the pin blocks are held in “perfect” registration with their respective articulator frames.

### BRIEF DESCRIPTIONS OF THE DRAWINGS

FIG. 1 is a view of a triple tray with clamping handle;

FIG. 2 is a cross section through a triple tray showing elastomeric compound with negative impressions;

FIG. 3 is an exploded perspective view of the upper articulator plate, pin block assembly and alignment pins;

FIG. 4 is a exploded perspective view of the cast-in-place tapered alignment posts attached to the pin block;

FIG. 5 is a exploded perspective view of a prefabricated, self-alignment post;

FIG. 6 shows an exploded view of the articulator with transparent pin location template;

FIG. 7 shows a perspective view of a mechanical over-center clamp to hold pin block; and

FIG. 8 shows a perspective view of two mechanical over-center clamps in use to secure a pin block to articulator frame.

### DETAILED DESCRIPTION OF THE DRAWINGS

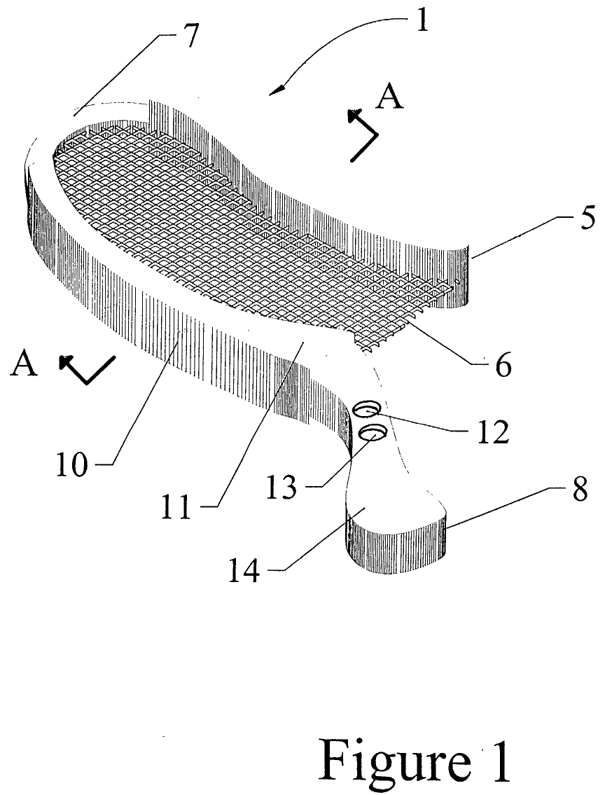

FIG. 1 details a typical triple tray 1 having a frame 11 with a buccal side 10, a transverse portion 7 and a lingual side 5. Mesh 6 is thin and flexible and offers minimal interference in the occusal plane during the taking of the simultaneous upper and lower impression. The frame is rigid to prevent distortion of the impression material. Handle 8 offers convenient placement and may be detachable. A section of the handle 8 is provided with clamping surfaces 12 and 13 that fit integrally within a mounting clamp attached to the articulator. These clamping surfaces allow the triple tray to be accurately positioned and held during the pouring and curing of the positive stone casts. The triple tray will be removed later. The clamp can be swung out of the working area of the articulator, if desired. The foundation for the clamp can be attached to either the upper or lower articulator frame or to one of the support arms joining the upper and lower articulator frames.

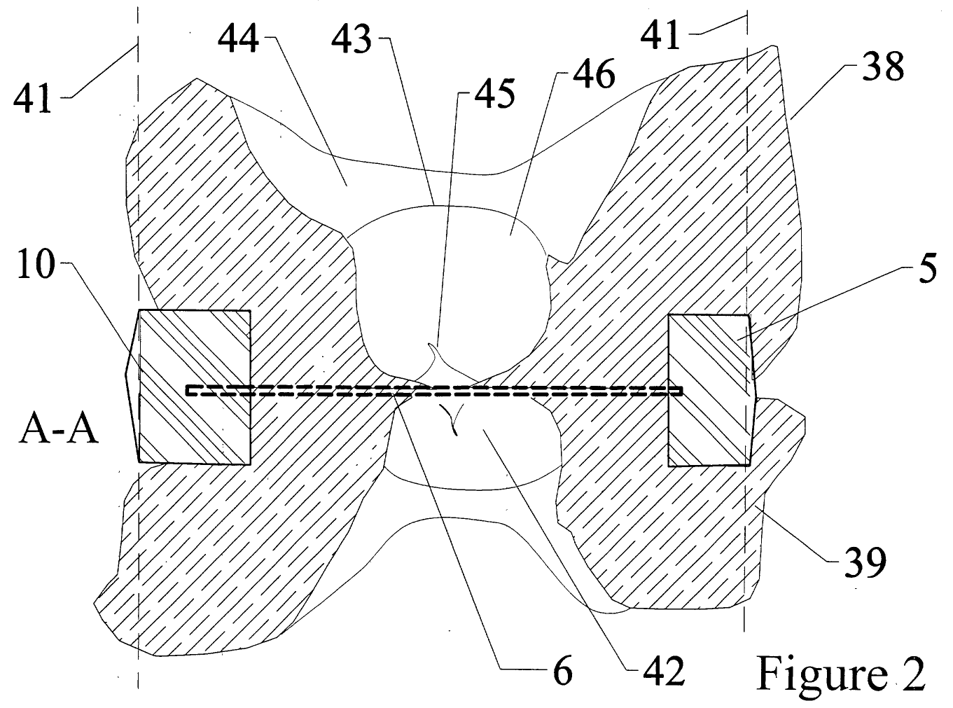

FIG. 2 details a transverse sectional view of a typical triple tray with impression material attached. Buccal side 10 and lingual side 5 are shown with the thin flexible open mesh 6. Upper impression material 38 and lower impression material 39 are linked through the open mesh 6 and hold negative impressions of the upper and lower dental arch. A negative image of an upper tooth 46, gum line 43, soft tissue 44 and occlusal surface features 45 are preserved in accurate detail. Impression of lower tooth 42 is in perfect registration with upper impression of tooth 46 in centric occlusion. Excess impression compound is trimmed with a scalpel from the outer perimeter of the triple tray frame along cut lines 41 if necessary to aid in pouring of stone compound.

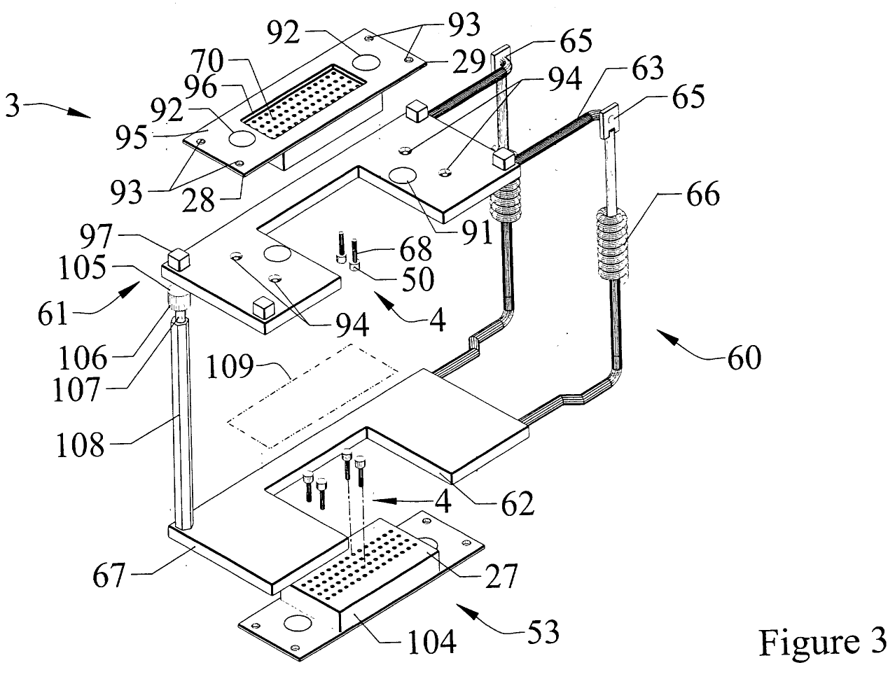

FIG. 3 details an exploded perspective view of the articulator 60 with upper pin block 3 and lower pin block 53. Pins 4 are equipped with a tapered shank 68 and knurled head 50. The tapered shanks of pins 4 removably slide into holes 70 to hold the stone cast on the pin block 3 with knurled head 50 captured within the hardened stone cast.

Each of the tapered through-holes 70 is temporarily occluded with a locally removable barrier to prevent egress of plaster slurry. Only those holes selected for pin use will have the barrier removed. The barrier prevents the slurry compound from locking into the pin block upon hardening.

Pin block 3 has embedded iron pole pieces 92 which act to hold the pin block to upper articulator frame 61 by means of embedded magnets 91. These magnets can be provided with both north and south poles on the exposed upper face to maximize the clamping force between the magnet and the iron pole piece. Other clamping means can be substituted to removably hold the end shelves 28 and 29 of the pin block to the upper surface of articulator frame 61. Through-hole wells 93 at the periphery of pin block shelves 28 and 29 are roughly centered over truncated-conical recesses 94 in upper articulator frame 61. These recesses will be filled with stone slurry to form a hardened stone alignment plug with a truncated conical projection matching the recesses 94. The upper stem of the stone alignment plug is captively fixed within through-hole 93 by suitable retaining means. A taper in the through-hole 93 widening toward the upper surface 95 of pin block 3 will act to retain the alignment plug. Alternately, a countersink located at the top of the through-hole will fix the alignment plug in place. By casting-in-place the alignment plugs, the pin block with pins 4 and solid models of dental stone casts can be removed and replaced as many times as necessary without the loss of placement accuracy. Feet 97 allow the articulator to stand level upon either frame face without disturbing the pin block positions. Articulator hinge 65 is fixed to top articulator plate 61 by arms 63 and to lower articulator plate 67 by rigid arms with flexible elements 66. Cutout areas 62 accommodate easy pin block placement, being larger than the periphery 104.

A forward stop acts to level the upper and lower stone models. The height of the stop is adjustable by turning screw head 106 which turns threaded shaft 107 in standoff 108. The top surface 105 of the screw head can be rounded to glide along a shaped surface on the underside of articulator frame 61 to mimic the lateral and forward angular motion of the jaw. A suitable clamp with jaws that grab the handle of the triple tray is mounted on the articulator. The triple tray is held with mesh 6 in the occlusal plane 109 of the articulator. The articulator is supplied with a forward stop and a rear stop have respective mating and tracking surfaces that hold both frames parallel in closure and guide the arc of motion of the jaw. These stops can be both removable and adjustable. A removable set of rear stops will maintain a parallel plane when constructing prosthetics for an edentulous ridge.

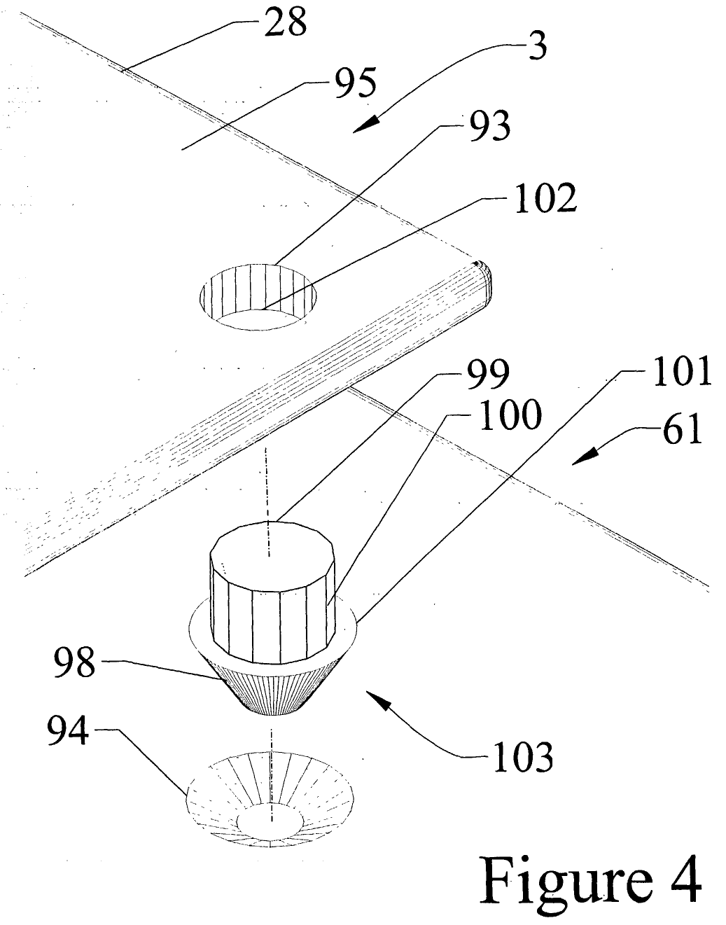

A closer perspective view in FIG. 4 shows upper pin block shelf 28 with upper surface 95 having at least two through holes represented by 93 with an inner wall 102 that flares outward toward upper surface 95 to retain the cast stem 99 of cast plug 103. Cast flared conical shaft 100 locks intimately within through-hole 93. Lower tapered conic portion 101 is molded within conical recess 94 located in the top surface of the articulator jaw 61. Surface 98 is formed in contact with recess 94.

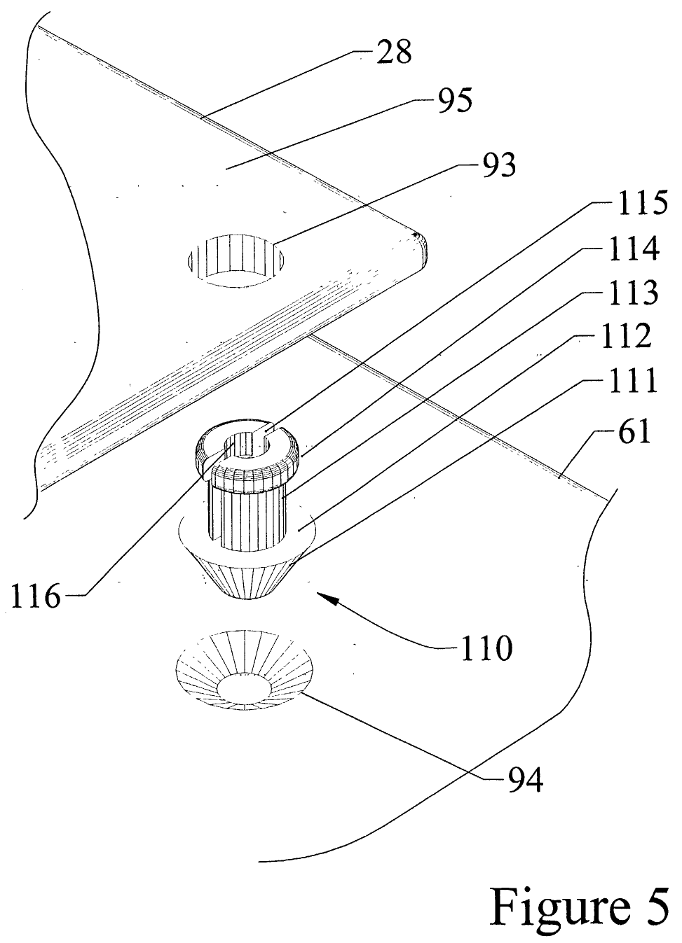

In an alternate embodiment detailed in FIG. 5, a pre-molded thermoplastic alignment plug 110 with a tapered conic portion 111, undercut face 112 and stem 113 is inserted in pin block shelf 28. The stem 113 is somewhat smaller than through-hole 93 to insure a loose fit. Widened head 114 and open groove 115 allow insertion and retain the alignment plug loosely within through-hole 93. Hollow recess 116 allows the application of any of a number of gluing compounds or stone casting compounds to fill in the gap between stem 112 and through-hole 93, after the pin block is set in place upon the articulator frame. The tapered conic portion 111 of each plug is firmly centered in each tapered recess 94. Any stone casting compound, epoxy or cyano-acrylate resin that maintains dimensional stability as it cures can be used to permanently and accurately fix the alignment plug stem 113 to the pin block through-hole 93. Then the pin block can be repeatedly removed and replaced in the articulator frame without loss of placement accuracy.

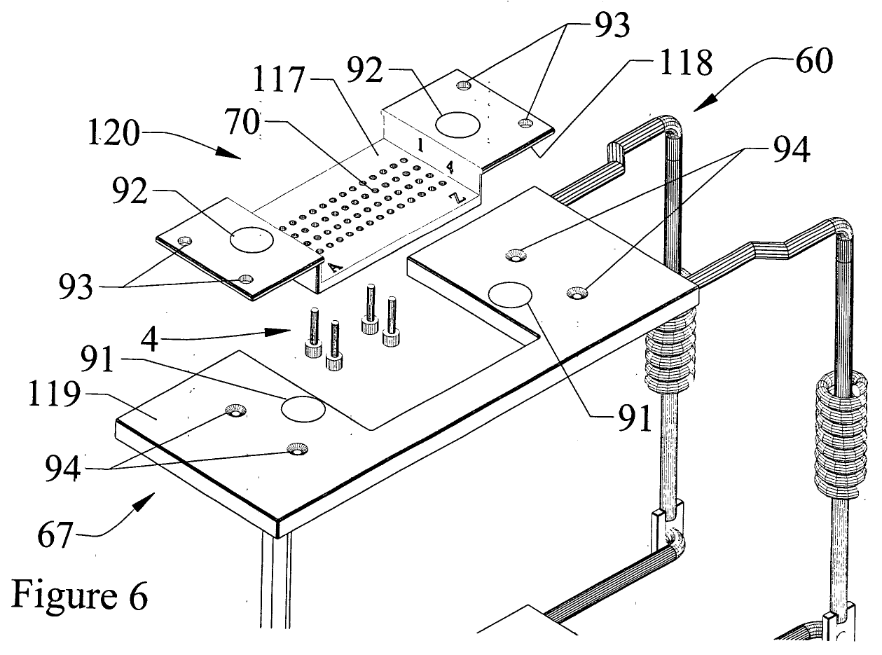

FIG. 6 details a clear plastic alignment template 120 having a set of through-holes marked with coordinate numbers shown as A-Z and 1-4 to help the dentist communicate to the laboratory the best pin positions for the pin blocks. The pin blocks have matching coordinated markings. The template is held in place with the same type of iron inserts 92 which are attracted to magnets 91 embedded in the external surface 119 of the articulator frame 67. Pins 4 can be tried into the through-holes 70 in close proximity to the negative impression in the triple tray elastomeric compound. Undersurface 118 of the template is held flush with surface 119 of the articulator frame. It should not be necessary to cast alignment plugs within the through-holes 93 and conical recesses 94 for this operation.

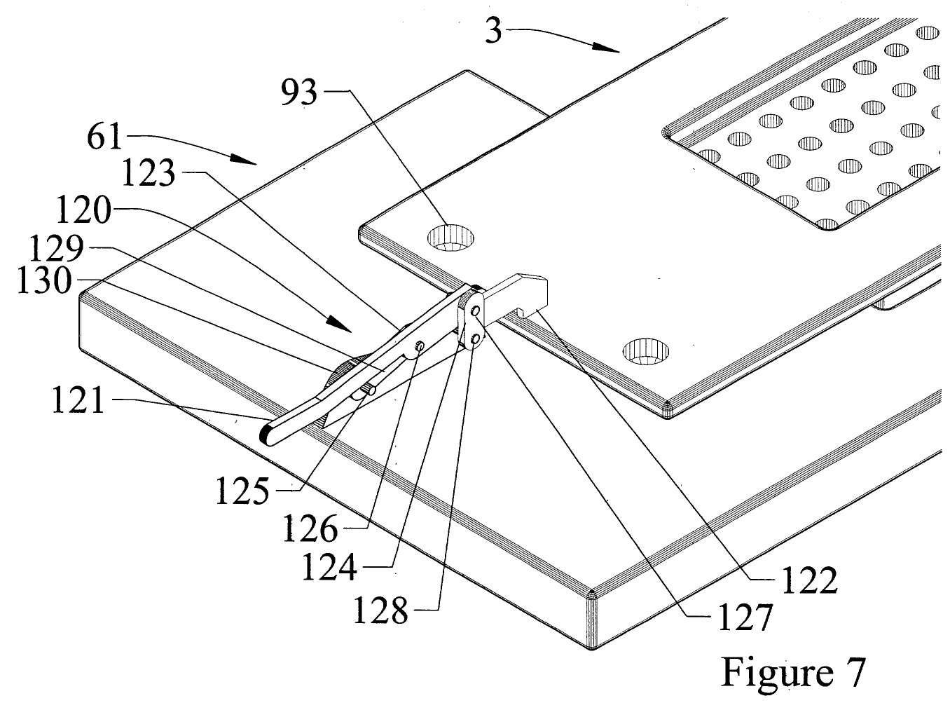

FIG. 7 details an alternate clamping means using a four-bar over-center clamp 120 integrally attached to the articulator frame 61 to hold pin block 3 firmly against the frame. This insures no vertical movement between the pin block and the frame. Pressing down with the finger on clamp handle 121 forces clamp end 122 to firmly press against upper surface of pin block 3. Hinge pins 125, 126, 127 and 128 allow the clamp members to rotate relative to each other. Link element 124 rotates to force clamp end 122 normal to the upper surface of pin block 3 with no shifting of the pin block. Frame 130 is attached to the surface of articulator frame 61. Link end 123 travels over center to act as a toggle latch. After clamping impression alignment wells 93 are ready to fill for perfect alignment.

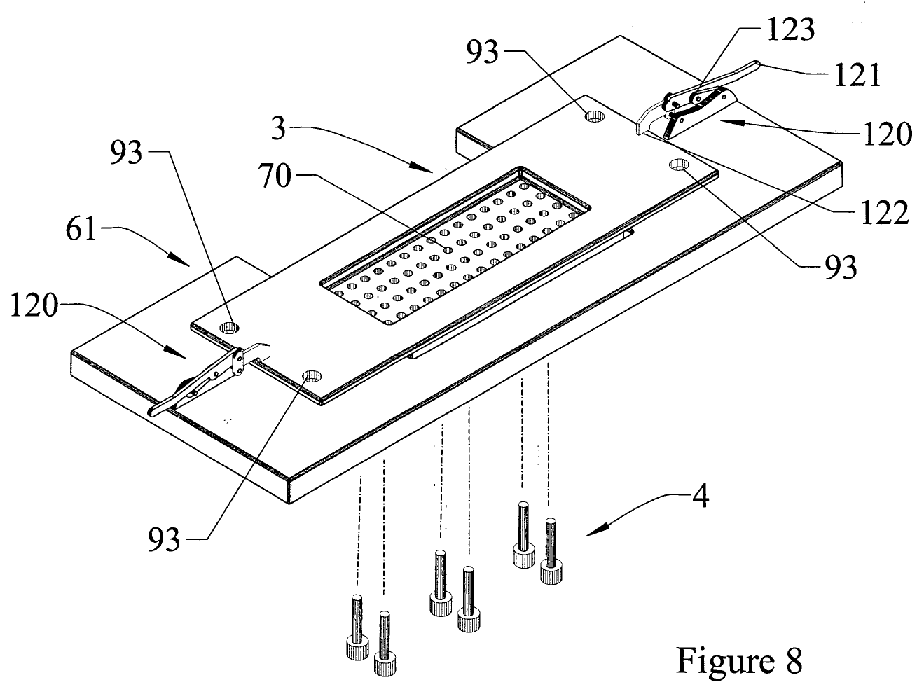

FIG. 8 shows two such over-center clamps holding down each end of the pin block to the articulator frame.

1. An apparatus for precise registration and articulation of opposing dental stone replicas comprised of a triple tray having a rigid frame and a thin porous membrane mounted on the frame in the occlusal plane;
an articulator having an upper and lower frame, upper and lower connecting arms attached to said articulator, said arms having hinged elements and flexing elements to mimic the complex motion of the human jaw;
a transparent, rigid polymer, upper pin block with a multitude of evenly spaced tapered through-holes;
a transparent, rigid polymer, lower pin block with a multitude of evenly spaced tapered through-holes;
a plurality of pins having a tapered base matching the tapered through-holes in said upper and lower pin blocks, the pins having embedding heads to hold said pins within said hardened dental stone replicas,
said upper and lower pin blocks having alignment through-holes located in proximity with alignment recesses on the respective upper and lower surfaces of said articulator upper and lower frames, each of said through-holes and said alignment recesses forming a casting mold for precise alignment plugs, said alignment plugs remaining fixed to said upper and lower pin blocks while parting easily from said articulator frame surface recesses;

2. An apparatus as cited in claim 1 comprising magnetic clamping means having a magnetically attractive alloy embedded within said pin block and magnets embedded within said articulator upper and lower frames.

3. An apparatus as cited in claim 1 comprised of loosely fitting snap-in alignment plugs installed in said pin block said each alignment through-hole for further fixing in precise place by gluing means.

4. An apparatus as cited in claim 1 comprising a clamping apparatus to maintain said triple tray frame level within said occlusal plane.

5. An application as cited in claim 1 in which said articulator pin blocks have identifying letters and numbers to uniquely locate said each through-hole.

6. An apparatus comprised of a thin transparent template with alignment holes mating with said alignment posts and with identifying letters and numbers to locate proper casting pin placement within stone replicas.

7. An apparatus as cited in claim 1 in which said articulator upper and lower frames have removable, adjustable frontal stops comprised of curved mating and tracking surfaces to mimic human jaw motion.

8. An apparatus as cited in claim 1 in which said articulator upper and lower frames have removable, adjustable rear stops comprised of curved mating and tracking surfaces to mimic human jaw motion.

9. An apparatus as cited in claim 1 having said triple tray frame comprised of at least one handle recess mating with at least one projection on said triple tray articulator clamp to maintain parallel placement.

10. An apparatus as cited in claim 1 having at least one clamp having a mechanical four-bar, over-center clamping motion attached to said articulator frame to removably clamp said pin block to said frame surface.

11. An apparatus as cited in claim 1 having said pin blocks comprised of tapered through holes, each of said through holes temporarily occluded with a locally removable barrier to prevent egress of plaster slurry.

12. An apparatus as cited in claim 1 having said pin blocks comprised of said tapered through holes, each of said through holes temporarily occluded with a removable polymer plug.
